(19) United States
(12) Patent Application Publication
(10) Pub. No.: US 2024/0236098 A1
(43) Pub. Date: Jul. 11, 2024

(54) BLOCKLIST GENERATION SYSTEM BASED ON REPORTED THREATS

(71) Applicant: KnowBe4, Inc., Clearwater, FL (US)

(72) Inventors: Anand Dinkar Bodke, Pune (IN); Eric Howes, Dunedin, FL (US); Mark William Patton, Clearwater, FL (US); Greg Kras, Dunedin, FL (US); Christopher Cline, St. Petersburg, FL (US); Brandon Scott Smith, Clearwater, FL (US); Steffan Perry, New Port Richey, FL (US)

(73) Assignee: KnowBe4, Inc., Clearwater, FL (US)

(21) Appl. No.: 18/533,517

(22) Filed: Dec. 8, 2023

Related U.S. Application Data
(60) Provisional application No. 63/443,891, filed on Feb. 7, 2023.

(30) Foreign Application Priority Data
Dec. 23, 2022 (IN) 202221075243

(51) Int. Cl. H04L 9/40

(52) U.S. Cl. CPC H04L 63/101

(57) ABSTRACT

Described herein are systems and methods to provide for blocklist recommendations based on reported threats. In an example embodiment, a method is described for receiving a selection of one or more messages from a plurality of messages identified as threats and identifying, based at least on the one or more messages, one or more candidate blocklist entries (BLEs). The method further includes determining, based at least on the one or more candidate BLEs, a recommendation of one or more BLEs to add to a blocklist. The method includes adding, by the one or more servers, the one or more BLEs to the blocklist, where the blocklist is used by an email system to block messages that match at least the one or more BLEs on the blocklist.

### RELATED APPLICATIONS

This application claims the benefit of and priority to Indian Provisional Application No. 202221075243, filed on Dec. 23, 2022, and tided “BLOCKLIST RECOMMENDATION ENGINE BASED ON REPORTED THREATS” and U.S. Provisional Application No. 63/443,891 filed on Feb. 7, 2023, and titled “BLOCKLIST GENERATION SYSTEM BASED ON REPORTED THREATS”, all of which are incorporated herein in their entirety for all purposes.

### TECHNICAL FIELD

This disclosure relates to security awareness management. In particular, the present disclosure relates to systems and methods for blocklist recommendations based on reported threats.

### BACKGROUND OF THE DISCLOSURE

Cybersecurity incidents cost companies millions of dollars each year in actual costs and can cause customers to lose trust in an organization. The incidents of cybersecurity attacks and the costs of mitigating the damage is increasing every year. Many organizations use cybersecurity tools such as antivirus, anti-ransomware, anti-phishing, and other quarantine platforms to detect and intercept known cybersecurity attacks. However, new, and unknown security threats involving social engineering may not be readily detectable by such cyber security tools, and the organizations may have to rely on their employees (referred to as users) to recognize such threats. To enable their users to stop or reduce the rate of cybersecurity incidents, the organizations may conduct security awareness training for their users. The organizations may conduct security awareness training through in-house cybersecurity teams or may use third-parties which are experts in matters of cybersecurity. The security awareness training may include cybersecurity awareness training, for example, via simulated phishing attacks, computer-based training, and other training programs. Through security awareness training, organizations educate their users on how to detect and report suspected phishing communications, avoid clicking on malicious links, and use applications and websites safely.

### BRIEF SUMMARY OF THE DISCLOSURE

Systems and methods are provided for blocklist recommendations based on reported threats. In an example embodiment, a method is described for receiving a selection of one or more messages from a plurality of messages identified as threats and identifying, based at least on the one or more messages, one or more candidate blocklist entries (BLEs). The method further includes determining, based at least on the one or more candidate BLEs, a recommendation of one or more BLEs to add to a blocklist. The method includes adding, by the one or more servers, the one or more BLEs to the blocklist, where the blocklist is used by an email system to block messages that match at least the one or more BLEs on the blocklist.

In some embodiments, the method includes receiving the plurality of messages from a threat detection system.

In some embodiments, the method includes adding, by the threat detection system, a label to the one or more messages to identify potential threats in the one or more messages.

In some embodiments, the method further includes receiving the selection of the one or more messages from an administrator via a user interface.

In some embodiments, the method further includes determining the recommendation of the one or more BLEs to add to the blocklist according to a BLE characteristic type of a plurality of BLE characteristic types.

In some embodiments, the method further includes providing a user interface to an administrator to select a priority level for which to block messages similar to the plurality of messages identified as threats.

In some embodiments, the method further includes determining the recommendation of the one or more BLEs based at least on the selected priority level.

In some embodiments, the method further includes determining a recommendation of a Time-To-Live (TTL) for each of the one or more BLEs.

In some embodiments, the blocklist is a private blocklist.

In some embodiments, the method includes receiving a global blocklist of one or more BLEs identified by a security services provider that aggregates private blocklists of multiple organizations.

In some embodiments, the method includes providing a priority indicator to each of the one or more BLEs, the priority indicator indicating an order for which each of the one or more BLEs are to be added to the blocklist used by the email system.

In some embodiments, the method includes determining an efficacy level for each of the one or more BLEs based at least on how often each of the one or more BLEs results in a message being blocked.

In another example embodiment, a system is described. The system includes one or more servers. The one or more servers are configured to receive a selection of one or more messages from a plurality of messages identified as threats, and identify, based at least on the one or more messages, one or more candidate blocklist entries (BLEs). The one or more servers are further configured to determine, based at least on the one or more candidate BLEs, a recommendation of one or more BLEs to add to a blocklist, and add, the one or more BLEs to the blocklist, wherein the blocklist is used by an email system to block messages that match at least the one or more BLEs on the blocklist.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 depicts an implementation of some of a server and client architecture of a system for determining and deploying blocklist entries (BLEs) into one or more blocklists of an organization, according to some embodiments;

FIG. 3 illustrates an example of a user interface presented to a system administrator, where the user interface presents information of a plurality of messages, according to some embodiments;

FIG. 4 describes an example of a message selected by the system administrator, according to some embodiments;

FIG. 5A and FIG. 5B illustrate an example of a user interface presented to the system administrator, where the user interface presents details of blocklist entry (BLE) characteristic types and corresponding BLEs related to a message, according to some embodiments;

FIG. 6A and FIG. 6B illustrate an example of a user interface presented to the system administrator, where the user interface provides Time-To-Live (TTL) information for BLEs, according to some embodiments;

FIG. 7 illustrates an example of a pop-up menu for adjusting the value of TTL for a BLE, according to some embodiments;

FIG. 8 illustrates an example of another pop-up menu for adjusting the value of TTL for the BLE, according to some embodiments;

FIG. 9 depicts a flowchart for determining a recommendation of one or more BLEs to add to a blocklist, according to some embodiments; and

FIG. 10A and FIG. 10B depict another flowchart for determining a recommendation of one or more BLEs to add to a blocklist, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that are useful for blocklist recommendations based on reported threats.

### A. Computing and Network Environment

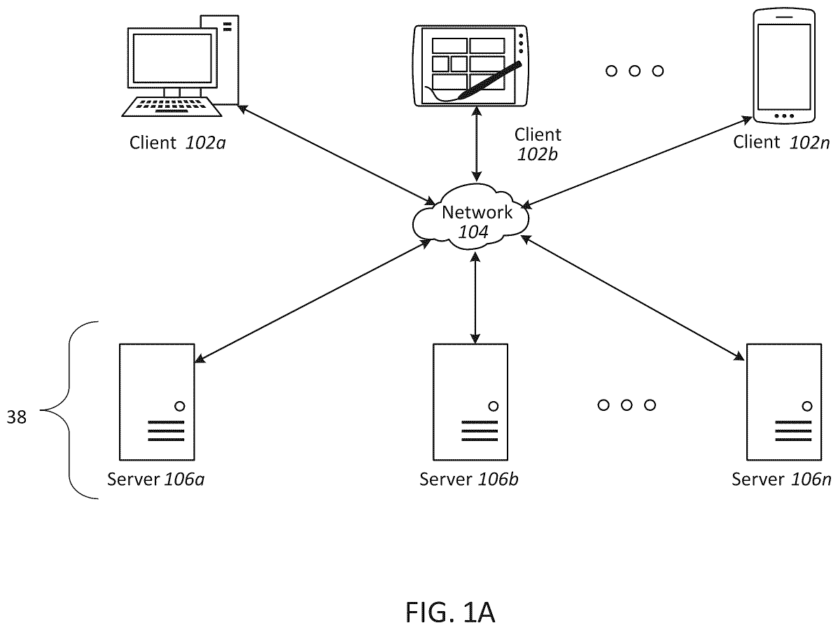

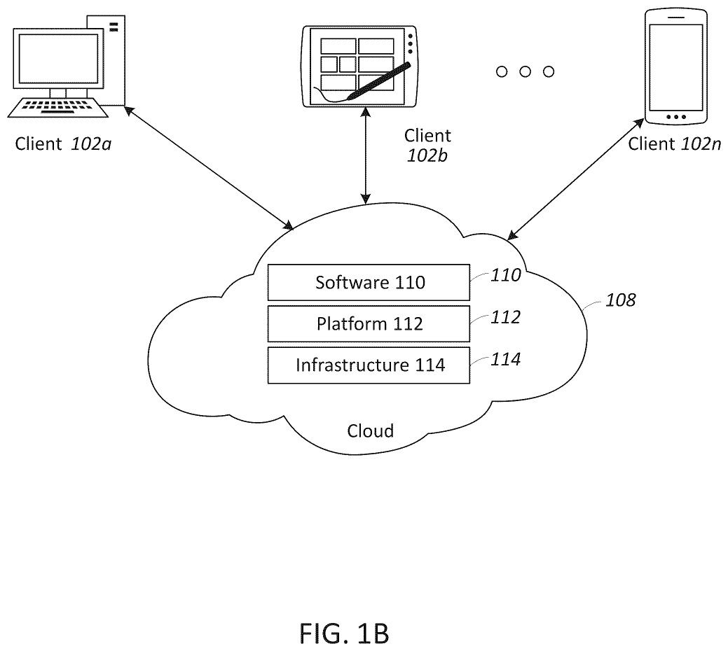

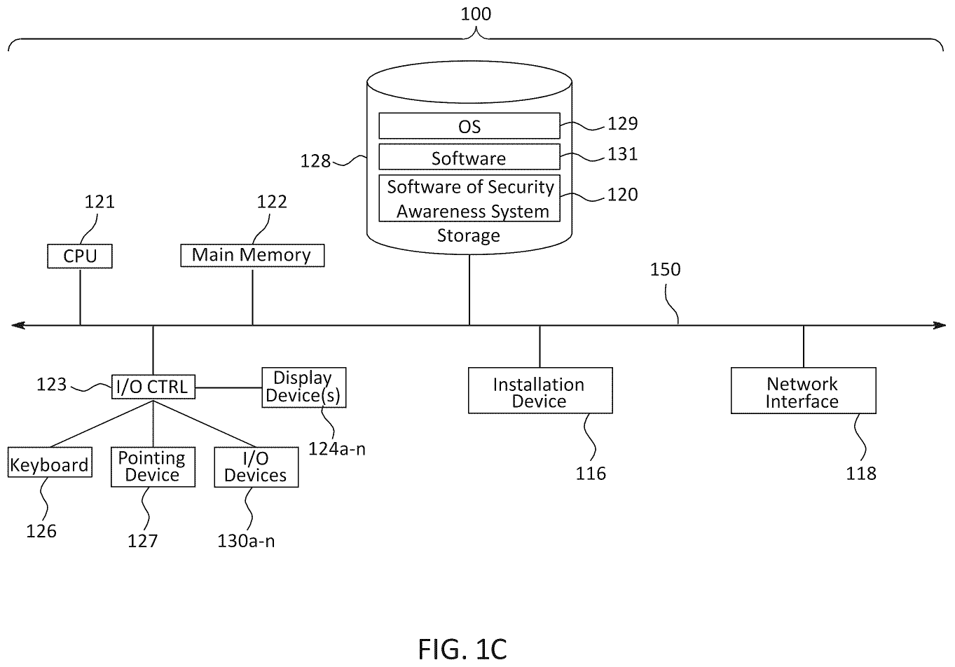

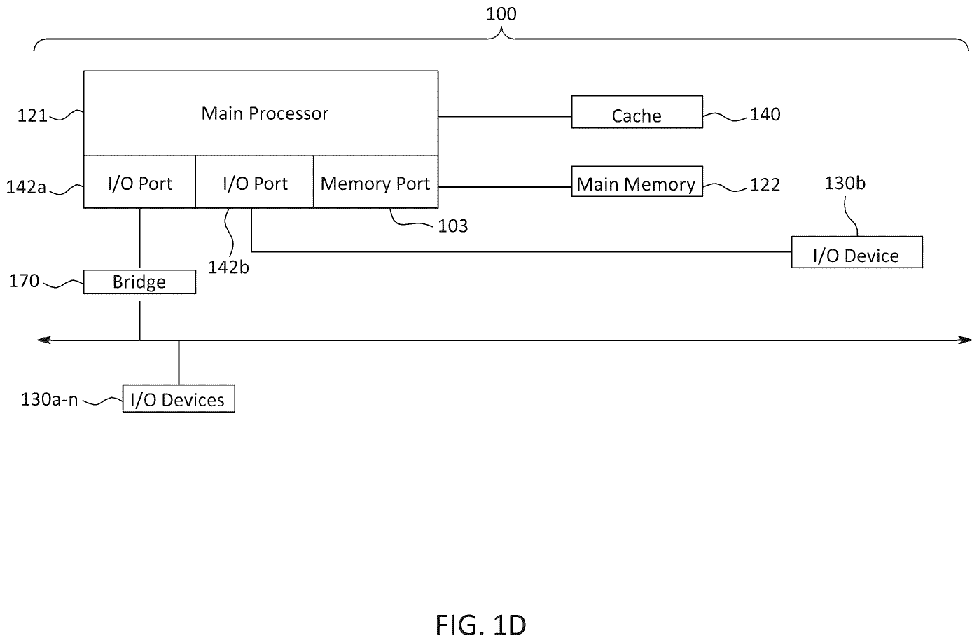

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv4 and IPv6), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, California; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems, and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers, or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g., Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g., Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit (CPU) 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an Operating System (OS) 129, software 131, and software of a security awareness system 120. As shown in FIG. 1D, each computing device 100 may also include additional optional elements, e.g., a memory port 103, a bridge 170, one or more Input/Output (I/O) devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the central processing unit 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile Random Access Memory (NVRAM), flash memory, non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the central processing unit 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the central processing unit 121 communicates directly with cache memory 140 via a secondary bus, sometimes referred to as a backside bus. In other embodiments, the central processing unit 121 communicates with cache memory 140 using the system bus 150. Cache memory 140 typically has a faster response time than main memory 122 and is typically provided by SRAM, BSRAM, or EDRAM. In the embodiment shown in FIG. 1D, the central processing unit 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the central processing unit 121 may use an Advanced Graphic Port (AGP) to communicate with the display 124 or the i/O controller 123 for the display 124. FIG. 1D depicts an embodiment of a computer 100 in which the central processing unit 121 communicates directly with I/O device 130b or other central processing units 121′ via HYPERTRANSPORT, RAPIDIO, or INFINIBAND communications technology. FIG. 1D also depicts an embodiment in which local busses and direct communication are mixed: the central processing unit 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices 130a-130n may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation device 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One of ordinary skill in the art will recognize and appreciate the various ways and embodiments that a computing device 100 may be configured to have multiple display devices 124a-124n.

Referring again to FIG. 1C, the computing device 100 may comprise storage device 128 (e.g., one or more hard disk drives or redundant arrays of independent disks) for storing an operating system or other related software, and for storing application software programs such as any program related to the software of security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices 128 may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and iOS, manufactured by Apple, Inc.; and Linux, a freely-available operating system, e.g., Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the iPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple lossless audio file formats and .mov, .m4v, and .mp4 MPEG-4 (H.264/MPEG-4 AVC) video file formats.

In some embodiments, the computing device 100 is a tablet e.g., the iPAD line of devices by Apple; GALAXY TAB family of devices by Samsung; or KINDLE FIRE, by Amazon.com, Inc. of Seattle, Washington. In other embodiments, the computing device 100 is an eBook reader, e.g., the KINDLE family of devices by Amazon.com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Blocklist Generation System Based on Reported Threats

The following describes systems and methods for blocklist recommendations based on reported threats.

Organizations may implement anti-phishing mechanisms (for example, anti-phishing software products) to identify and stop phishing attacks (or cybersecurity attacks) before phishing messages reach the users. These anti-phishing mechanisms may rely on a database of threat definition files (also called signatures) to stop malicious attacks associated with phishing messages. However, phishing messages having new signatures or involving new techniques may evade the anti-phishing mechanisms and may reach the users. A new phishing attack that has not yet been identified is called a Zero-Day attack. The length of time for a signature (or a threat definition file) to be released for a new phishing attack may be several days whereas the first victim of a phishing attack typically falls for it within minutes of its release. In examples, a first indication of a Zero-Day attack to an organization is when the Zero-Day attack reaches a mailbox of a user of the organization. Consequently, the organizations may be at a security risk, possibly leading to breach of the organizations' sensitive information if the users were to act up on the phishing messages that may form part of the Zero-Day attack.

In examples, third-party antivirus software products and operating system security options such as Microsoft Defender rely on threat definition files to identify and block incoming phishing messages. Since, it takes time for Zero-Day attacks to be reflected in threat definition files and for updated threat definition files to be transmitted to corporate systems, the organizations may be vulnerable for that time period. In an example, each phishing message may include several characteristics, each of which could be used to block further instances of the phishing message or its variants before the phishing message or its variants reach additional users. These characteristics may be used to create one or more blocklist entries (BLEs) in a blocklist. In an example, a BLE may be understood as a single rule that relates to a characteristic of an email threat (phishing message) that may be used by an email server to quarantine email threats. In examples, each BLE may be of a single characteristic type which, when present in an inbound email, provides an indication to the email server that the email is malicious. However, there is a limit as to how many BLEs of each different characteristic type may be supported. The BLE characteristic types may include sender characteristic type (such as sender email address or sender domain), body URLs characteristic type (such as URL domain or URL path, wildcards supported for both), and attachment characteristic type (such as SHA256 hash of the attachment). Therefore, it is essential that the BLEs that make up the blocklist are capable of preventing Zero-Day attacks from reaching users of the organizations. Accordingly, systems and methods to provide faster protection from Zero-Day attacks based on one or more blocklists are needed.

Blocklists may protect organizations by blocking emails that match a set of blocklist rules included in the blocklists. In examples, Microsoft 365 (Office365) supports a limited number of types of blocklist rules, including sender email addresses, sender domains, domains found in the email body, uniform resource locator (URLs) found in the email body (which may be wildcarded), and attachments (by SHA256 hash of the attachments). In an example, SHA256 hash may be a cryptographic hash function. Currently, the number of each of these types of blocklist rules is limited. For example, up to 500 sender email addresses or sender domains may be specified to be blocked, up to 500 URLs may be specified to be blocked, and up to 500 total file attachment SHA256 hashes may be specified to be blocked. In examples, blocked emails may be routed into users' junk folders.

The present disclosure describes systems and methods for blocklist recommendations based on reported threats. The systems and methods enable faster protection from Zero-Day attacks by facilitating rapid determination and deployment of BLEs into one or more blocklists of an organization.

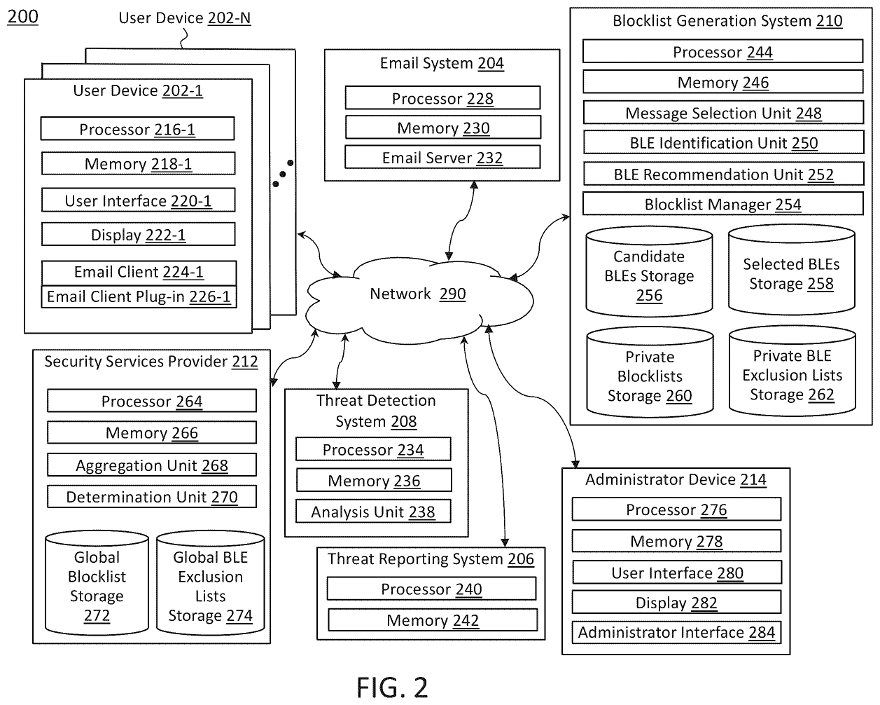

Referring to FIG. 2, in a general overview, FIG. 2 depicts some of the server architecture of an implementation of system 200 for determining and deploying BLEs into one or more blocklists of an organization, according to some embodiments. System 200 may be a part of security awareness system 120. System 200 may include user device(s) 202-(1-N), email system 204, threat reporting system 206, threat detection system 208, blocklist generation system 210, security services provider 212, administrator device 214, and network 290 enabling communication between the system components for information exchange. Network 290 may be an example or instance of network 104, details of which are provided with reference to FIG. 1A and its accompanying description.

According to some embodiments, each of email system 204, threat reporting system 206, threat detection system 208, blocklist generation system 210, and security services provider 212 may be implemented in a variety of computing systems, such as a mainframe computer, a server, a network server, a laptop computer, a desktop computer, a notebook, a workstation, and the like. In an implementation, email system 204, threat reporting system 206, threat detection system 208, blocklist generation system 210, and security services provider 212 may be implemented in a server, such as server 106 shown in FIG. 1A. In some implementations, email system 204, threat reporting system 206, threat detection system 208, blocklist generation system 210, and security services provider 212 may be implemented by a device, such as computing device 100 shown in FIG. 1C and FIG. 1D. In some embodiments, email system 204, threat reporting system 206, threat detection system 208, blocklist generation system 210, and security services provider 212 may be implemented as a part of a cluster of servers. In some embodiments, each of email system 204, threat reporting system 206, threat detection system 208, blocklist generation system 210, and security services provider 212 may be implemented across a plurality of servers, thereby, tasks performed by each of email system 204, threat reporting system 206, threat detection system 208, blocklist generation system 210, and security services provider 212 may be performed by the plurality of servers. These tasks may be allocated among the cluster of servers by an application, a service, a daemon, a routine, or other executable logic for task allocation.

Referring again to FIG. 2, in one or more embodiments, user device 202-(1-N) may be any device used by a user (all devices of user device 202-(1-N) are subsequently referred to as user device 202-1 however, the description may be generalized to any of user device 202-(1-N)). The user may be an employee of an organization, a client, a vendor, a customer, a contractor, a system administrator (interchangeably referred to as an administrator), or any person associated with the organization. User device 202-1 may be any computing device, such as a desktop computer, a laptop, a tablet computer, a mobile device, a Personal Digital Assistant (PDA), or any other computing device. In an implementation, user device 202-1 may be a device, such as client device 102 shown in FIG. 1A and FIG. 1B. User device 202-1 may be implemented by a device, such as computing device 100 shown in FIG. 1C and FIG. 1D. According to some embodiments, user device 202-1 may include processor 216-1 and memory 218-1. In an example, processor 216-1 and memory 218-1 of user device 202-1 may be CPU 121 and main memory 122, respectively, as shown in FIG. 1C and FIG. 1D. User device 202-1 may also include user interface 220-1, such as a keyboard, a mouse, a touch screen, a haptic sensor, a voice-based input unit, or any other appropriate user interface. It shall be appreciated that such components of user device 202-1 may correspond to similar components of computing device 100 in FIG. 1C and FIG. 1D, such as keyboard 126, pointing device 127, I/O devices 130a-n and display devices 124a-n. User device 202-1 may also include display 222-1, such as a screen, a monitor connected to the device in any manner, or any other appropriate display, which may correspond to similar components of computing device 100, for example display devices 124a-n. In an implementation, user device 202-1 may display received content (for example, messages) for the user using display 222-1 and is able to accept user interaction via user interface 220-1 responsive to the displayed content.

In some embodiments, user device 202-1 may include email client 224-1. In one example, email client 224-1 may be a cloud-based application that may be accessed over network 290 without being installed on user device 202-1. In an implementation, email client 224-1 may be any application capable of composing, sending, receiving, and reading email messages. In an example, email client 224-1 may facilitate a user to create, receive, organize, and otherwise manage email messages. In an implementation, email client 224-1 may be an application that runs on user device 202-1. In some implementations, email client 224-1 may be an application that runs on a remote server or on a cloud implementation and is accessed by a web browser. For example, email client 224-1 may be an instance of an application that allows viewing of a desired message type, such as any web browser, Microsoft Outlook™ application (Microsoft, Mountain View, California), IBM® Lotus Notes® application, Apple® Mail application, Gmail® application (Google, Mountain View, California), WhatsApp™ (Facebook, Menlo Park, California), a text messaging application, or any other known or custom email application. In an example, a user of user device 202-1 may be mandated to download and install email client 224-1 on user device 202-1 by the organization. In an example, email client 224-1 may be provided by the organization as default. In some examples, a user of user device 202-1 may select, purchase and/or download email client 224-1 through an application distribution platform. Other user devices 202-(2-N) may be similar to user device 202-1.

In one or more embodiments, email client 224-1 may include email client plug-in 226-1. An email client plug-in may be an application or program that may be added to an email client for providing one or more additional features or customizations to existing features. The email client plug-in may be provided by the same entity that provides the email client software or may be provided by a different entity. In an example, email client plug-in may provide a User Interface (UI) element such as a button to enable a user to trigger a function. Functionality of client-side plug-ins that use a UI button may be triggered when a user clicks the button. Some examples of client-side plug-ins that use a button UI include, but are not limited to, a Phish Alert Button (PAB) plug-in, a task create plug-in, a spam marking plug-in, an instant message plug-in, a social media reporting plug-in and a search and highlight plug-in. In an embodiment, email client plug-in 226-1 may be any of the aforementioned types or may be of any other type.

In some implementations, email client plug-in 226-1 may not be implemented in email client 224-1 but may coordinate and communicate with email client 224-1. In some implementations, email client plug-in 226-1 is an interface local to email client 224-1 that supports email client users. In one or more embodiments, email client plug-in 226-1 may be an application that supports the user, e.g., recipients of messages, to select to report suspicious messages that they believe may be a threat to them or their organization. Other implementations of email client plug-in 226-1 not discussed here are contemplated herein. In one example, email client plug-in 226-1 may provide the PAB plug-in through which functions or capabilities of email client plug-in 226-1 are triggered/activated by a user action on the button. Upon activation, email client plug-in 226-1 may forward content (for example, suspicious messages) to a system administrator. In some embodiments, email client plug-in 226-1 may cause email client 224-1 to forward content to the system administrator, or an Incident Response (IR) team of the organization for threat triage or threat identification. The system administrator may be an individual or team responsible for managing organizational cybersecurity aspects on behalf of an organization. For example, the system administrator may oversee Information Technology (IT) systems of the organization for configuration of system personal information use, identification and classification of threats within reported emails. Examples of system administrator include an IT department, a security administrator, a security team, a manager, or an Incident Response (IR) team. In some embodiments, email client 224-1 or email client plug-in 226-1 may send a notification to threat reporting system 206 that a user has reported content received at email client 224-1 as potentially malicious. Thus, in examples, the PAB plug-in button enables a user to report suspicious content.

Referring again to FIG. 2, email system 204 may be an email handling system owned or managed or otherwise associated with an organization or any entity authorized thereof. In an implementation, email system 204 may be configured to receive, send, and/or relay outgoing emails between message senders (for example, third-party to the organization) and recipients (for example, user devices 202-(1-N)). In an implementation, email system 204 may include processor 228, memory 230, and email server 232. In an example, processor 228 and memory 230 of email system 204 may be CPU 121 and main memory 122, respectively, as shown in FIG. 1C and FIG. 1D.

In an implementation, email server 232 may be any server capable of handling, receiving, and delivering emails over network 290 using one or more standard email protocols and standards, such as Post Office Protocol 3 (POP3), Internet Message Access Protocol (IMAP), Simple Mail Transfer Protocol (SMTP), and Multipurpose Internet Mail Extension (MIME). Email server 232 may be a standalone server or a part of an organization's server. In an implementation, email server 232 may be implemented using, for example, Microsoft® Exchange Server, and HCL Domino®. In an implementation, email server 232 may be a server 106 shown in FIG. 1A.

In some embodiments, threat reporting system 206 may be a platform that enables users to report messages that the users find to be suspicious or believe to be malicious, through email client plug-ins 226-(1-N) or any other suitable means. In some examples, threat reporting system 206 may be configured to manage a deployment of and interactions with email client plug-ins 226-(1-N), allowing the users to report the suspicious messages directly from email clients 224-(1-N). According to some embodiments, threat reporting system 206 may include processor 240 and memory 242. For example, processor 240 and memory 242 of threat reporting system 206 may be CPU 121 and main memory 122, respectively, as shown in FIG. 1C and FIG. 1D.

According to some embodiments, threat detection system 208 may be a platform that monitors, identifies, and manages cybersecurity attacks including phishing attacks faced by the organization or by users within the organization. In an implementation, threat detection system 208 may be configured to analyze messages that are reported by users to detect any cybersecurity attacks such as phishing attacks via malicious messages. A malicious message may be a message that is designed to trick a user into causing the download of malicious software (for example, viruses, Trojan horses, spyware, or worms) that is of malicious intent onto a computer. The malicious message may include malicious elements. A malicious element is an aspect of the malicious message that, when interacted with, downloads or installs malware onto a computer. Examples of malicious element include a URL or link, an attachment, and a macro. The interactions may include clicking on a link, hovering over a link, copying a link and pasting it into a browser, opening an attachment, downloading an attachment, saving an attachment, attaching an attachment to a new message, creating a copy of an attachment, executing an attachment (where the attachment is an executable file), and running a macro. The malware (also known as malicious software) is any software that is used to disrupt computer operations, gather sensitive information, or gain access to private computer systems. Examples of malicious messages include phishing messages, smishing messages, vishing messages, malicious IM, or any other electronic message designed to disrupt computer operations, gather sensitive information, or gain access to private computer systems. Threat detection system 208 may use information collected from identified cybersecurity attacks and analyze messages to prevent further cybersecurity attacks.

According to some embodiments, threat detection system 208 may include processor 234 and memory 236. For example, processor 234 and memory 236 of threat detection system 208 may be CPU 121 and main memory 122, respectively, as shown in FIG. 1C and FIG. 1D. According to an embodiment, threat detection system 208 may include analysis unit 238. In an implementation, analysis unit 238 may be applications or programs communicatively coupled to processor 234 and memory 236. In some embodiments, analysis unit 238, amongst other units, may include routines, programs, objects, components, data structures, etc., which may perform particular tasks or implement particular abstract data types. Analysis unit 238 may also be implemented as signal processor(s), state machine(s), logic circuitries, and/or any other device or component that manipulate signals based on operational instructions.

In some embodiments, analysis unit 238 may be implemented in hardware, instructions executed by the processing module, or by a combination thereof. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to perform the required functions. In some embodiments, analysis unit 238 may be machine-readable instructions which, when executed by a processor/processing module, perform intended functionalities of analysis unit 238. The machine-readable instructions may be stored on an electronic memory device, hard disk, optical disk, or other machine-readable storage medium or non-transitory medium. In an implementation, the machine-readable instructions may also be downloaded to the storage medium via a network connection. In an example, machine-readable instructions may be stored in memory 236.

Referring back to FIG. 2, in some embodiments, blocklist generation system 210 may be a system that may be owned or managed or otherwise associated with an organization or any entity authorized thereof. The organization may be an entity that is subscribed to or that makes use of services provided by blocklist generation system 210. In examples, the organization may be expanded to include all users within the organization, vendors to the organization, or partners of the organization. In an implementation, blocklist generation system 210 may manage blocklists for the organization to address the threat of Zero-Day attacks. In an example, the blocklists may include private blocklists. A private blocklist may be a collection of private BLEs that make up the blocklist that was created by, and is private to, a single organization. The private blocklist may include up to 500 private BLEs per BLE characteristic. The BLE characteristic may include one of sender characteristic (such as sender email address or sender domain), body URLs characteristic (such as URL domain or URL path, wildcards supported for both), and attachment characteristic (such as SHA256 hash of the attachment). In examples, a private BLE may be a single BLE that may be a part of a private blocklist that was created by an organization (or by a system administrator of that organization). In examples, private BLEs may be private to a single organization. In examples, the private BLEs may have priority over global BLEs, and may not be modified as part of global blocklist processing. Details of the global BLEs and the global blocklist are provided later in the disclosure.

According to some embodiments, blocklist generation system 210 may include processor 244 and memory 246. For example, processor 244 and memory 246 of blocklist generation system 210 may be CPU 121 and main memory 122, respectively, as shown in FIG. 1C and FIG. 1D. According to some embodiments, blocklist generation system 210 may further include message selection unit 248, BLE identification unit 250, BLE recommendation unit 252, and blocklist manager 254. In an implementation, message selection unit 248, BLE identification unit 250, BLE recommendation unit 252, and blocklist manager 254, amongst other units, may include routines, programs, objects, components, data structures, etc., which may perform particular tasks or implement particular abstract data types.

In some embodiments, message selection unit 248, BLE identification unit 250, BLE recommendation unit 252, and blocklist manager 254 may be implemented in hardware, instructions executed by a processing module, or by a combination thereof. In examples, the processing module may be main processor 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, message selection unit 248, BLE identification unit 250, BLE recommendation unit 252, and blocklist manager 254 may be machine-readable instructions which, when executed by a processor/processing module, perform intended functionalities of message selection unit 248, BLE identification unit 250, BLE recommendation unit 252, and blocklist manager 254. The machine-readable instructions may be stored on an electronic memory device, hard disk, optical disk, or other machine-readable storage medium or non-transitory medium. In an implementation, the machine-readable instructions may also be downloaded to the storage medium via a network connection.

In some embodiments, blocklist generation system 210 may include candidate BLEs storage 256, selected BLEs storage 258, private blocklists storage 260, and private BLE exclusion lists storage 262. In an implementation, candidate BLEs storage 256 may include one or more candidate BLEs. In examples, the candidate BLEs may be candidates for identification of potential BLEs. In an implementation, selected BLEs storage 258 may include one or more selected BLEs (or one or more recommended BLEs) that may be added to one or more blocklists. In an implementation, private blocklists storage 260 may include one or more private blocklists associated with the organization. In an implementation, private BLE exclusion lists storage 262 may include one or more private BLE exclusion lists associated with the organization. In examples, a private BLE exclusion list may be a list that may be created and maintained by an organization. The private BLE exclusion list may include all blocklist characteristics that may not be pushed into the organization's email server. Any private BLE that conflicts with an entry on the private BLE exclusion list may not be added to the private blocklist (for example, until the conflict is resolved). In examples, the candidate BLEs stored in candidate BLEs storage 256, the selected BLEs stored in selected BLEs storage 258, the private blocklists stored in private blocklists storage 260, and the private BLE exclusion lists stored in private BLE exclusion lists storage 262 may be periodically or dynamically updated as required.

Referring back to FIG. 2, in some embodiments, security services provider 212 may be an entity that aggregates multiple private blocklists obtained from multiple organizations and selects a subset of the private blocklists to create a global blocklist. The global blocklist may be a collection of global BLEs that make up the blocklist and may be published by security services provider 212. The global blocklist may be available to organizations that subscribe to the services of security services provider 212. In examples, private BLEs may be collected by security services provider 212 for the purpose of determining if they are candidates for inclusion into the global blocklist. A private BLE may have valuable characteristics that may be considered as a candidate to become a global BLE in the global blocklist. According to some embodiments, security services provider 212 may use information gained from access to the private blocklists of multiple organizations to provide additional information to organizations such as BLE characteristics and BLE recommendations.

According to some embodiments, security services provider 212 may include processor 264 and memory 266. For example, the processor 264 and memory 266 of security services provider 212 may be CPU 121 and main memory 122, respectively, as shown in FIG. 1C and FIG. 1D. According to some embodiments, security services provider 212 may further include aggregation unit 268 and determination unit 270. In an implementation, aggregation unit 268 and determination unit 270, amongst other units, may include routines, programs, objects, components, data structures, etc., which may perform particular tasks or implement particular abstract data types.

In some embodiments, aggregation unit 268 and determination unit 270 may be implemented in hardware, instructions executed by a processing module, or by a combination thereof. In examples, the processing module may be main processor 121, as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to performing the required functions. In some embodiments, aggregation unit 268 and determination unit 270 may be machine-readable instructions which, when executed by a processor/processing module, perform intended functionalities of aggregation unit 268 and determination unit 270. The machine-readable instructions may be stored on an electronic memory device, hard disk, optical disk, or other machine-readable storage medium or non-transitory medium. In an implementation, the machine-readable instructions may also be downloaded to the storage medium via a network connection.

According to an implementation, aggregation unit 268 may be configured to aggregate multiple private blocklists obtained from multiple organizations. Further, in an implementation, determination unit 270 may be configured to determine a global blocklist based on selecting a subset of the BLEs in the multiple private blocklists. In examples, determination unit 270 may be identify private BLEs included in the private blocklists that may be candidates for inclusion into the global blocklist. In examples, if the probability of a private BLE to block non-malicious emails is very low, or if the private BLE is the first instance of a particular BLE (an indicator that it is associated with a Zero-Day attack), or if the efficacy level of the private BLE is already high, or is trending higher, then the private BLE may be considered as a candidate to become a global BLE in the global blocklist. An efficacy level is a measure of how many malicious emails that were reported to security services provider 212 contained a particular BLE characteristic.

According to some embodiments, determination unit 270 may be configured to determine one or more global BLE exclusion lists. A global BLE exclusion list may include all the blocklist characteristics that may be common across both threat and non-threat emails, and are therefore not acceptable for usage in a BLE.

In some embodiments, security services provider 212 may include global blocklist storage 272 and global BLE exclusion lists storage 274. In an implementation, global blocklist storage 272 may include a global blocklist. In an implementation, global BLE exclusion lists storage 274 may include one or more global BLE exclusion lists. In examples, the global blocklist stored in global blocklist storage 272 and the global BLE exclusion lists stored in global BLE exclusion lists storage 274 may be periodically or dynamically updated as required.

In some embodiments, administrator device 214 may be any device used by a user or a system administrator or a security administrator to perform administrative duties. The system administrator may be an individual or team responsible for managing organizational cybersecurity aspects on behalf of an organization. The system administrator may oversee and manage blocklist generation system 210. In an example, the system administrator may oversee Information Technology (IT) systems of the organization for configuration of system personal information use, identification and classification of threats within reported emails. Examples of system administrator include an IT department, a security administrator, a security team, a manager, or an Incident Response (IR) team. In an implementation, administrator device 214 may be any computing device, such as a desktop computer, a laptop, a tablet computer, a mobile device, a Personal Digital Assistant (PDA), smart glasses, or any other computing device. In an implementation, administrator device 214 may be a device, such as client device 102 shown in FIG. 1A and FIG. 1B. Administrator device 214 may be implemented by a device, such as computing device 100 shown in FIG. 1C and FIG. 1D. According to some embodiments, administrator device 214 may include processor 276 and memory 278. In an example, processor 276 and memory 278 of administrator device 214 may be CPU 121 and main memory 122, respectively, as shown in FIG. 1C and FIG. 1D. Administrator device 214 may also include user interface 280, such as a keyboard, a mouse, a touch screen, a haptic sensor, a voice-based input unit, or any other appropriate user interface. It shall be appreciated that such components of administrator device 214 may correspond to similar components of computing device 100 in FIG. 1C and FIG. 1D, such as keyboard 126, pointing device 127, I/O devices 130a-n and display devices 124a-n. In some embodiments, administrator device 214 may include display 282, such as a screen, a monitor connected to the device in any manner, a wearable glass, or any other appropriate display. In some implementations, administrator device 214 may include administrator interface 284. Administrator interface 284 may be supported by a library, an application programming interface (API), a set of scripts, or any other code that may enable the system administrator to manage blocklist generation system 210 and other components of system 200.

In operation, a user of user device 202-1 may receive a message (for example, an email) in his or her mailbox. In an implementation, the user may receive the message from email system 204. On receiving the message, if the user suspects that the message is suspicious and potentially malicious, the user may report the message using email client plug-in 226-1. In an implementation where email client plug-in 226-1 provides a UI element such as a button in email client 224-1 of user device 202-1 and when the user suspects that the message is malicious, the user may click on the UI element to report the message. The user may click on the UI element using, for example, a mouse pointer, and the user may click on the UI element when the message is open or when the message is highlighted in a list of inbox messages.

In some implementations, when the user selects to report the message via email client plug-in 226-1, email client plug-in 226-1 may receive an indication that the message was reported by the user of user device 202-1 as a suspected malicious message. In response, email client plug-in 226-1 may cause email client 224-1 to forward the reported message or a copy of the reported message to threat reporting system 206. Threat reporting system 206 may forward the reported message or a copy of the reported message to threat detection system 208 for threat analysis.

In some embodiments, in response to receiving the indication that the user has reported the message, email client plug-in 226-1 causes email client 224-1 to forward the reported message or a copy of the reported message to threat detection system 208 for threat analysis. In some examples, the user may proactively forward the message to a system administrator who, in turn, may send the message to threat reporting system 206 and/or threat detection system 208. According to an implementation, upon receiving the reported message or the copy of the reported message, threat detection system 208 may process the reported message to determine whether the message is a malicious message. Various combinations of reporting, retrieving, and forwarding the message to threat reporting system 206 and threat detection system 208 not described are contemplated herein.

In a similar manner as described above, threat reporting system 206 may receive messages that have been reported, for example, by one or more users of the organization. Further, threat detection system 208 may analyze the reported messages. In examples, threat detection system 208 may identify or classify a plurality of messages from amongst the reported messages as threats. According to an implementation, analysis unit 238 of threat detection system 208 may add a label to each of the plurality of messages. The labels may assist in the identification of potential threats in the plurality of messages. In examples, adding labels to the messages may enable the system administrator to prioritize assessment of the messages that are most likely to be threats. According to some embodiments, analysis unit 238 may analyze the reported messages to identify the plurality of messages as threats.

According to an implementation, message selection unit 248 of blocklist generation system 210 may be configured to receive the plurality of messages that have been identified as threats from threat detection system 208. In examples, the plurality of messages may be verified threat messages. In an implementation, upon receiving the plurality of messages that have been identified as threats, message selection unit 248 may facilitate selection of one or more messages from amongst the plurality of messages that may be candidates for identification of potential BLEs. A BLE may be understood as a single rule that may provide a characteristic of a threat email that may be used by an email server to block and quarantine threat emails. In an example, a BLE may have a single BLE characteristic which, when present in an inbound email, notifies the email server that the email is malicious. In examples, a BLE characteristic of an email may be the characteristic of the email that identifies the email as a threat. For Microsoft 365, the BLE characteristic that identifies an email as a threat may be one of sender characteristic (such as sender email address or sender domain), body URLs characteristic (such as URL domain or URL path, wildcards supported for both), and attachment characteristic (such as SHA256 hash of the attachment). In an implementation, message selection unit 248 may present the plurality of messages received from threat detection system 208 to the system administrator via a user interface (for example, administrator interface 284).

In an implementation, the system administrator may analyze the plurality of messages to generate a recommendation of a subset of the plurality of messages that are candidates for identification of potential BLEs. In an example, the subset of the plurality of messages may include one or more messages from amongst the plurality of messages identified as threats. In an implementation, the system administrator may assign a rank to each of the one or more messages, where the rank is a measure of severity of threat associated with a message. In an example, the recommendation of the one or more messages may be understood as a selection of the one or more messages from amongst the plurality of messages identified as threats.

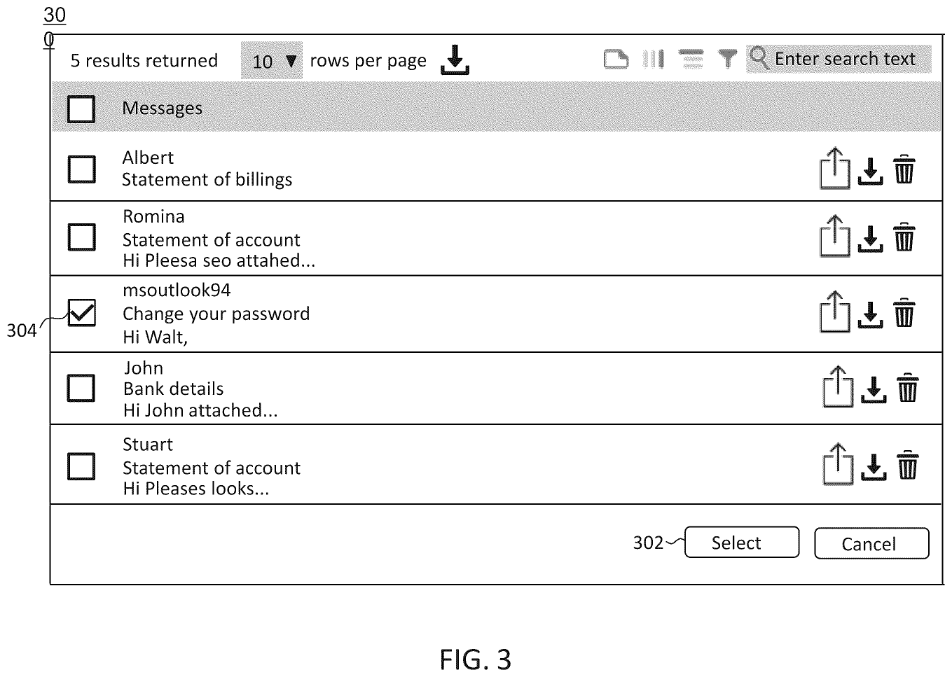

FIG. 3 illustrates example 300 of a user interface presented to the system administrator, where the user interface presents information of the plurality of messages received by message selection unit 248 from threat detection system 208, according to some embodiments.

In an implementation, each message may be represented by a tab or selectable element. The system administrator may be enabled to view a message by clicking on, or hovering over, the message. In the example shown in FIG. 3, the system administrator may choose to select a message, for example, by clicking on a checkbox corresponding to the message and further by clicking on select button 302. Reference number “304” represents an example of the selected checkbox.

Referring back to FIG. 2, according to an implementation, the system administrator may provide the selection of one or more messages to message selection unit 248. In an implementation, message selection unit 248 may receive the selection of the one or more messages from the plurality of messages identified as threats from the system administrator via a user interface (for example, administrator interface 284). In examples, each of the one or more messages may be a verified threat message (for example, verified by the system administrator). In an example, the system administrator may select the messages based on the severity of threat associated with the messages. For example, if a message demands urgent action, then is highly likely for the system administrator to select the message for further processing.

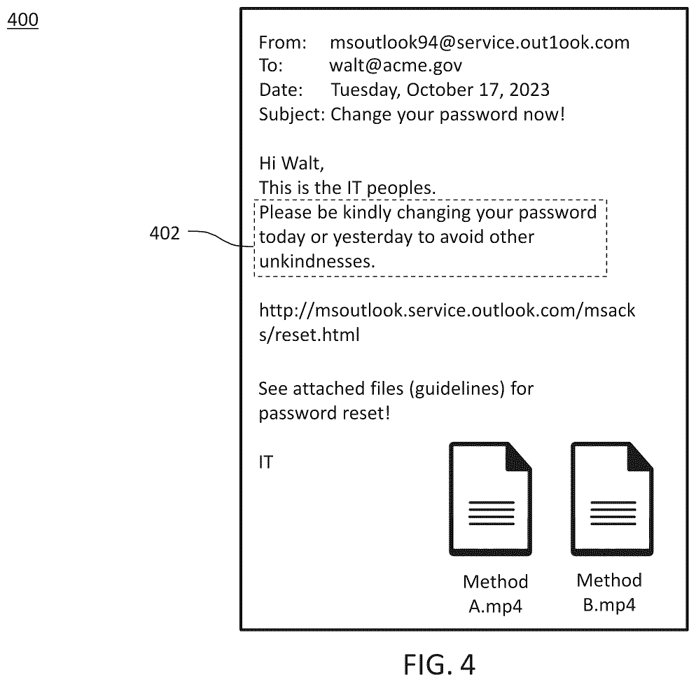

FIG. 4 describes example 400 of a message selected by the system administrator, according to some embodiments. In the example shown in FIG. 4, the message demands urgent action (represented by reference number “402”). Also, the message includes bad grammar, spelling mistakes, and suspicious attachments.

According to an implementation, BLE identification unit 250 may be configured to analyze the one or more selected messages to identify one or more candidate BLEs. According to an implementation, BLE identification unit 250 may extract all possible BLE characteristic types and associated BLEs from the one or more selected messages. In examples, BLE identification unit 250 may be configured to identify one or more candidate BLEs for each of the one or more selected messages. Referring to the message described in FIG. 4, examples of candidate BLEs for each BLE characteristic type are described in Table 1 provided below.

TABLE 1
BLE characteristic types and associated BLEs

| BLE Characteristic | |
|---|---|
| Type | Candidate BLE |
| Sender | msoutlook94@service.outlook.com (sender |
| | email address) |
| | service.outlook.com (sender domain) |
| Body URL | msoutlook.service.outlook.com/msacks/reset.html |
| | msoutlook.service.outlook.com/msacks/ |
| | Msacks |
| | *.msacks |
| | .msacks* |
| | *.msacks /* |
| | ~msacks |
| Attachment | SHA256[method A.mp4] |
| | SHA256[method B.mp4] |

According to an implementation, BLE identification unit 250 may be configured to present (or display) the one or more candidate BLEs to the system administrator. In some implementations, BLE identification unit 250 may display some or all of the BLE characteristic types of each message to the system administrator, where the BLE characteristic types may be used by the system administrator to create at least one BLE. In an implementation, the system administrator may create one or more candidate BLEs for each message by selecting one or more of the BLE characteristic types corresponding to the message. According to an implementation, BLE identification unit 250 may store the one or more candidate BLEs in candidate BLEs storage 256.

In an implementation, BLE recommendation unit 252 may be configured to determine, based at least on the one or more candidate BLEs, a recommendation of one or more BLEs to add to a blocklist. In an example, the blocklist may be a private blocklist and the one or more BLEs may be referred to as one or more private BLEs. In an implementation, BLE recommendation unit 252 may determine the recommendation of the one or more BLEs for adding to the blocklist according to a BLE characteristic type of a plurality of BLE characteristic types. In an implementation, BLE recommendation unit 252 may assess each of the one or more candidate BLEs for each BLE characteristic type and identify one or more BLEs for adding to the blocklist. According to an implementation, BLE recommendation unit 252 may store the one or more selected BLEs in selected BLEs storage 258.

In an implementation, BLE recommendation unit 252 may be configured to balance out a tolerance to false positives (e.g., a message blocked by the blocklist which is not a threat message) and the need to capture similar messages to the reported messages that have been identified as threats. In an implementation, BLE recommendation unit 252 may provide a user interface (for example, administrator interface 284) to the system administrator to select a priority level for which to block messages similar to the plurality of messages identified as threats. In implementations, the priority level may also be considered as a confidence level. The terms priority level and confidence level may be used interchangeably. In examples, the user interface may include a slider control for selection of the priority levels. In some implementations, the system administrator may use the slider control to determine a recommendation of which type of BLE characteristic type to use in creating BLEs or which BLEs to recommend. In an implementation, BLE recommendation unit 252 may determine the recommendation of the one or more BLEs based at least on the selected priority level. In examples, a priority level indicates the priority that a BLE should be given when the BLE is added to a blocklist. In an implementation, the priority level may be calculated based on the estimated severity of the message threat, and a measure of the efficacy of messages that contain the BLE characteristic.

In an implementation, BLE recommendation unit 252 may operate and store a private BLE exclusion list in private BLE exclusion lists storage 262. The private BLE exclusion list may be used to ensure that critical messages (or emails) related to the organization are never blocked by a BLE. As described earlier, the number of BLEs that can currently be pushed into Microsoft Exchange Online is limited to 500 entries per BLE characteristic type. Also, there may not be sufficient open entries for a given BLE characteristic type to support the new BLEs of that BLE characteristic type. BLE recommendation unit 252 may take this into account when determining the recommendation of one or more BLEs for adding to the blocklist. In an implementation, BLE recommendation unit 252 may provide a priority indicator to each of the one or more BLEs. The priority indicator may be “HIGH”, “MEDIUM” or “LOW”. The priority indicator may indicate an order for which each of the one or more BLEs are to be added to the blocklist used by email system 204. In an implementation, each BLE may be tagged with a priority indicator and then pushed into the private blocklist in priority order until all available entries for that BLE characteristic type are used. In an example, a BLE tagged with the priority indicator “HIGH” may be pushed into the private blocklist first, and a BLE tagged with the priority indicator “LOW” may be pushed into the private blocklist at the end. In some implementations, BLE recommendation unit 252 may recommend or select only those BLEs that may be added to the blocklist within the available open BLEs of a given BLE characteristic type.

According to an implementation, BLE recommendation unit 252 may present a list of BLE characteristic types to the system administrator. The system administrator may select one or more BLE characteristic types from the list of BLE characteristic types. In some implementations, based on the one or more BLE characteristic types selected by the system administrator, BLE recommendation unit 252 may present a recommendation of BLEs to the system administrator for review and approval. In an implementation, when presenting the BLE characteristic types to the system administrator, BLE recommendation unit 252 may indicate the number of available BLEs for each of the BLE characteristic types. The system administrator may choose to select (or approve) or delete one or more of the recommended BLEs. In some examples, the system administrator may also request a list of additional recommended BLEs.

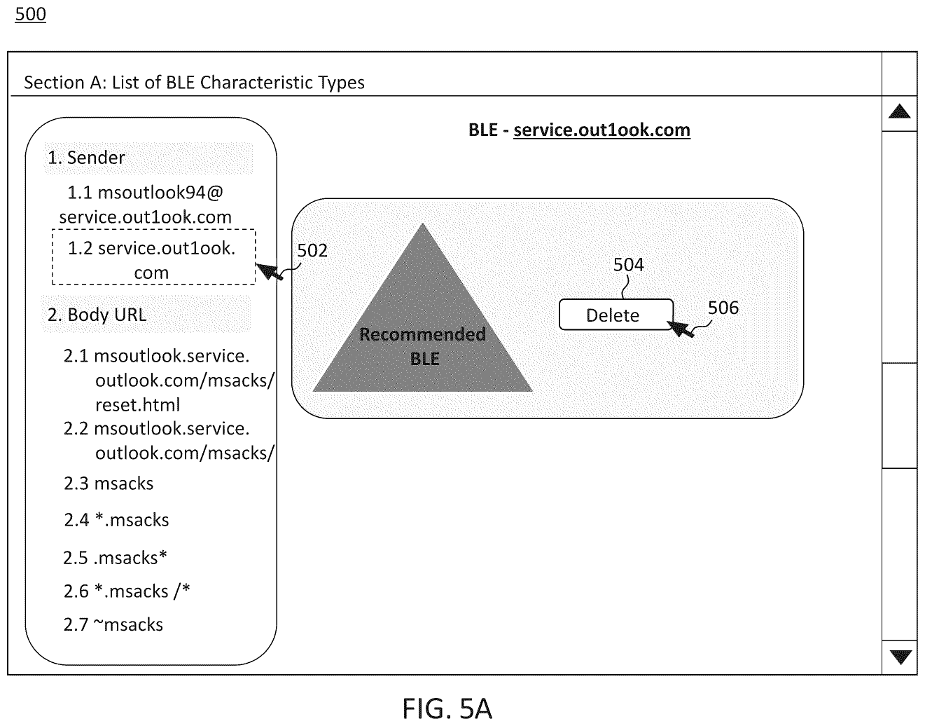

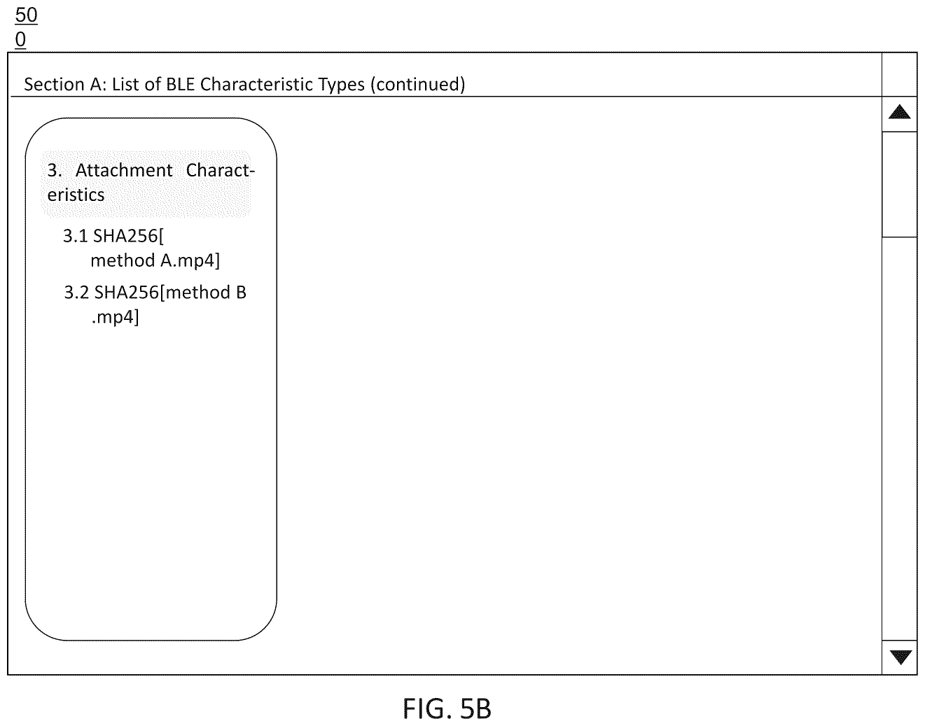

FIG. 5A and FIG. 5B illustrate example 500 of a user interface presented to the system administrator, where the user interface presents details of BLE characteristic types and corresponding BLEs related to a message, according to some embodiments.

In the example shown in FIG. 5A, the system administrator selects (for example, using mouse pointer 502) the BLE “service.outlook.com”. When the system administrator selects or clicks on the BLE “service.outlook.com”, details of the BLE “service.outlook.com” are displayed to the system administrator. As shown in FIG. 5A, it is displayed that the BLE “service.outlook.com” is a recommended BLE. In an implementation, the system administrator may be provided with an option to delete the recommended BLE such that the BLE is not added to the blocklist. In examples, the system administrator may delete the BLE by clicking on delete button 504, for example using mouse pointer 506. Upon deletion, the recommended BLE may not be added to the blocklist.

In examples, phishing messages may pose a threat for a limited amount of time before they are neutralized by other means. A Time-to-Live (TTL) may be specified for each BLE, and after that TL has expired, the BLE may be automatically deleted from the blocklist. In an implementation, BLE recommendation unit 252 may determine a recommendation of a TTL for each of the one or more BLEs. Referring to example 400 described in FIG. 4, BLE recommendation unit 252 may determine a recommendation of TTL as 5 days for the BLE “service.outlook.com”, a recommendation of TTL as 10 days for the BLE “˜msacks”, a recommendation of TTL as 4 days for the BLE “SHA256[method A.mp4]”, and a recommendation of TTL as 4 days for the BLE “SHA256[method B.mp4]”.

According to an implementation, blocklist manager 254 may receive the one or more selected BLEs from BLE recommendation unit 252. In an implementation, blocklist manager 254 may add the one or more selected BLEs to the blocklist, where the blocklist is used by email system 204 to block messages that match at least the one or more BLEs on the blocklist. According to an implementation, blocklist manager 254 may also receive a global blocklist of one or more BLEs identified by security services provider 212 that aggregates private blocklists of multiple organizations. In some implementations, blocklist manager 254 may also receive additional information related to BLE recommendations and recommendations for the TTL for BLEs from security services provider 212.

In examples, when considering whether to use a global BLE or other recommendations provided by security services provider 212, blocklist manager 254 may present additional information to the system administrator to assist the system administrator in assessing whether or not the global BLE is likely to be relevant to the cybersecurity of the organization. The additional information may include graphical information, size information, and industry information.

In examples, security services provider 212 may provide insights into the efficacy of types of BLEs or BLE characteristics or TTL that have been added to the blocklist by the organization in a given location or region. In some examples, security services provider 212 may make recommendations on BLEs, or BLE characteristic types, or TTL values for the BLEs based on the location or region of the organization. Further, security services provider 212 may provide insights into the efficacy of types of BLEs, or BLE characteristic types, or TTL values for the BLEs that have been added to blocklist by the organization of a given size. In some examples, security services provider 212 may make recommendations on BLEs, or BLE characteristic types, or TTL values for the BLEs based on the size of the organization. Also, security services provider 212 may provide insights into the efficacy of BLEs, BLE characteristic types, or TTL values for the BLEs that have been added to the blocklist by the organization in a given industry or sector of industry. Further, security services provider 212 may make recommendations on BLEs, or BLE characteristic types, or TTL values for the BLEs based on the industry or sector of industry of the organization.

In an implementation, blocklist manager 254 may translate the one or more selected BLEs into the blocklist. Also, blocklist manager 254 may push the blocklist into Microsoft Exchange Online via an API function. In examples, messages that match the BLEs included in the blocklist may be blocked and routed into junk folders of mailboxes of the users. As previously stated, the number of BLEs that can currently be pushed into Microsoft Exchange Online is limited to 500 entries per characteristic type. Accordingly, there may not be sufficient open entries for a given BLE characteristic type to support the new BLEs of that BLE characteristic type. In examples, if a reported message that has been classified as a threat is detected by different BLE characteristic types, blocklist manager 254 may consider only those BLE characteristic types that have capacity for new BLEs.

According to an implementation, blocklist manager 254 may receive information from email system 204 on how often each existing BLE results in a message being blocked. The information may be used to define an efficacy level for each BLE, where a BLE with a higher efficacy level may block more messages than a BLE with a lower efficacy level. In examples, efficacy level is a measure of how many malicious messages (emails) that were reported included the BLE characteristic. The efficacy calculation factors the age of the reported message into its calculation and lowering the weighting of messages as they age. According to an implementation, blocklist manager 254 may remove or recommend the removal of BLEs that have low efficacy levels. In an implementation, blocklist manager 254 may present all the BLEs to the system administrator to allow the system administrator to choose which one or more of the existing BLEs to replace or remove. In examples, the existing BLEs presented to the system administrator may be ordered by their efficacy level. In an implementation, blocklist manager 254 may determine an efficacy level for each of the one or more BLEs based at least on how often each of the one or more BLEs results in a message being blocked.

In an implementation, blocklist manager 254 may present the BLEs and associated TTL values to the system administrator on a user interface (for example, administrator interface 284). In examples, blocklist manager 254 may present the BLEs ordered by their remaining TTL value to the system administrator. In an example, the BLE that is due to expire first is presented first to the system administrator. According to an implementation, blocklist manager 254 may provide an indication of how many messages are blocked by each BLE over time. In examples, the delay in actual blocked messages for each BLE may be taken into account when recommending BLEs that may be removed or replaced with new BLEs. The delay in actual blocked messages may be as a result of a Zero-Day attack becoming less prevalent as malicious actors move to new and less well known threats. In an implementation, blocklist manager 254 may receive input from the system administrator to remove a BLE from the blocklist.

According to an implementation, the system administrator may have an option of adjusting the values of recommended TTLs for the BLEs. In examples, the user interface may include a slider control or a spin button control (also known as an up-down control) for adjusting the value of recommended TTLs for the recommended BLEs. In some implementations, blocklist manager 254 may put upper and lower limits on the TTL values. Accordingly, the system administrator may choose the TTL values in between the upper limits and the lower limits. In some implementations, the system administrator may provide his or her own values for TTLs for the BLEs.

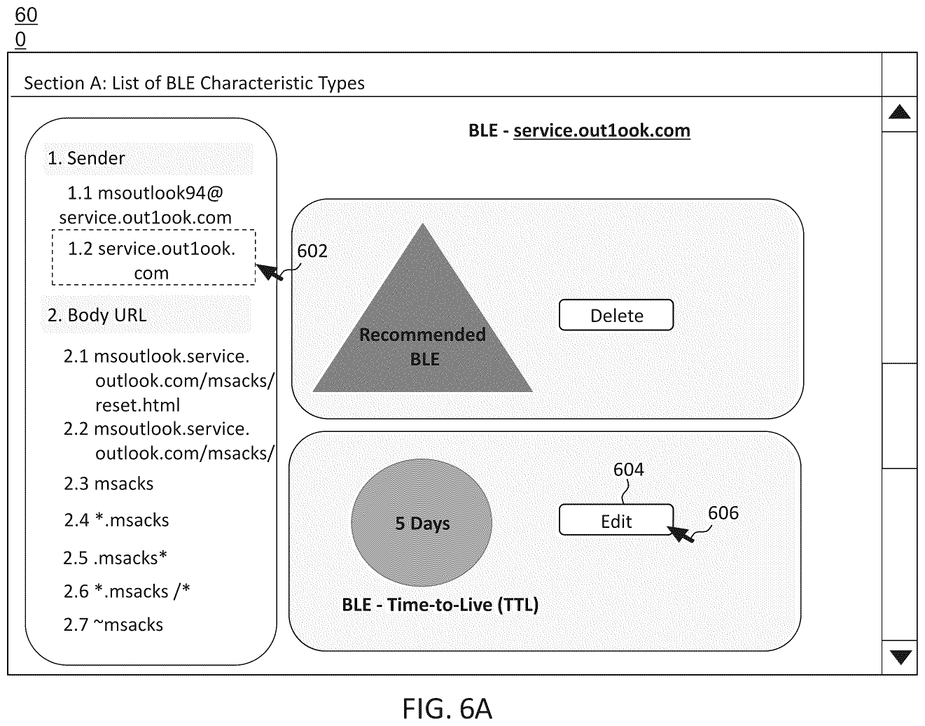

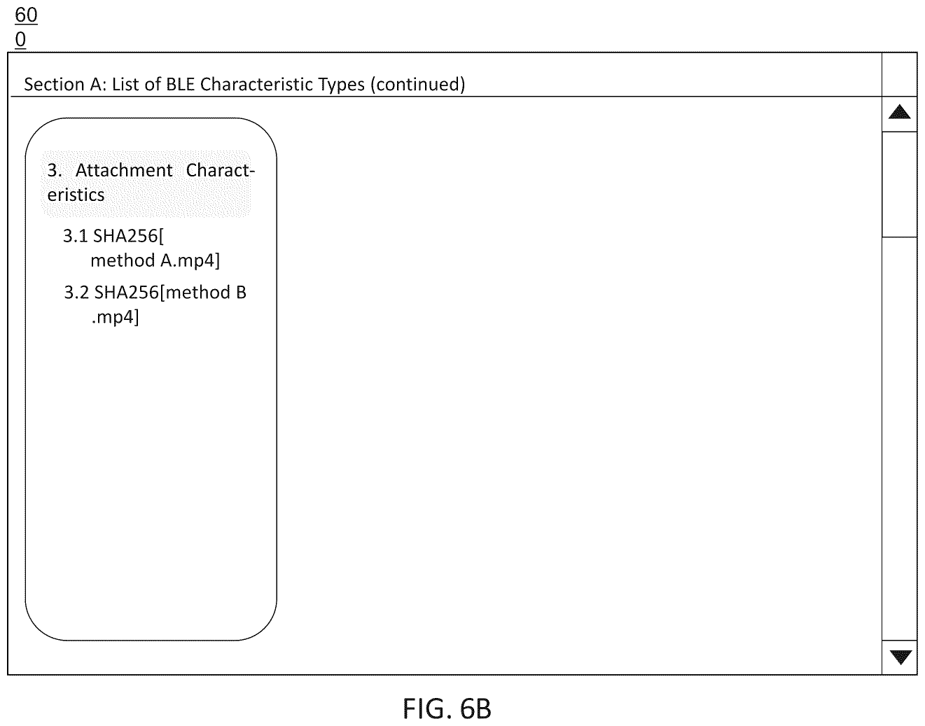

FIG. 6A and FIG. 6B illustrate example 600 of a user interface presented to the system administrator, where the user interface provides TTL information for BLEs, according to some embodiments.

In the example shown in FIG. 6A, the system administrator selects the BLE “service.outlook.com” by clicking on, or hovering over, the BLE “service.outlook.com”, for example, using mouse pointer 602. When the system administrator selects the BLE “service.outlook.com”, information about the BLE “service.outlook.com” is displayed. As shown in FIG. 6A, it is displayed that the BLE “service.outlook.com” is a recommended BLE. Further, TTL for the BLE “service.outlook.com” is 5 days. In an implementation, system administrator may adjust the recommended TTL value by clicking on edit button 604, for example, using mouse pointer 606.

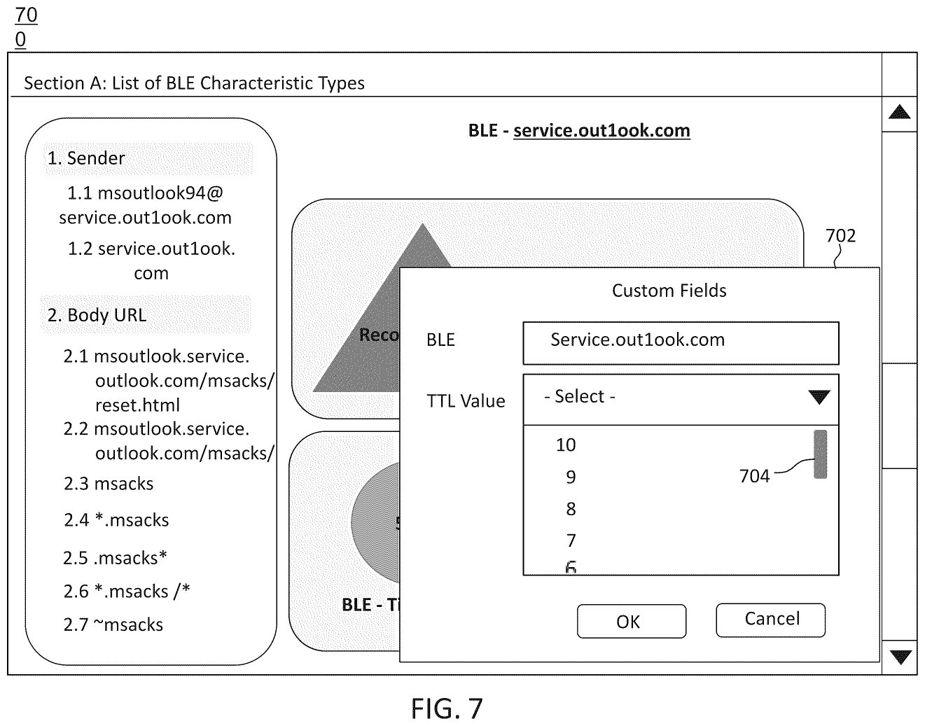

FIG. 7 illustrates an example of pop-up menu 702 for adjusting the value of TTL for the BLE “service.outlook.com”, according to some embodiments.

In an implementation, if the system administrator clicks on edit button 604 (as shown in FIG. 6A), pop-up menu 702 is displayed to the system administrator. As shown in FIG. 7, pop-up menu 702 displays an option to modify the TTL value for the BLE “service.outlook.com”. In examples, the system administrator may modify the TTL value using slider control 704.

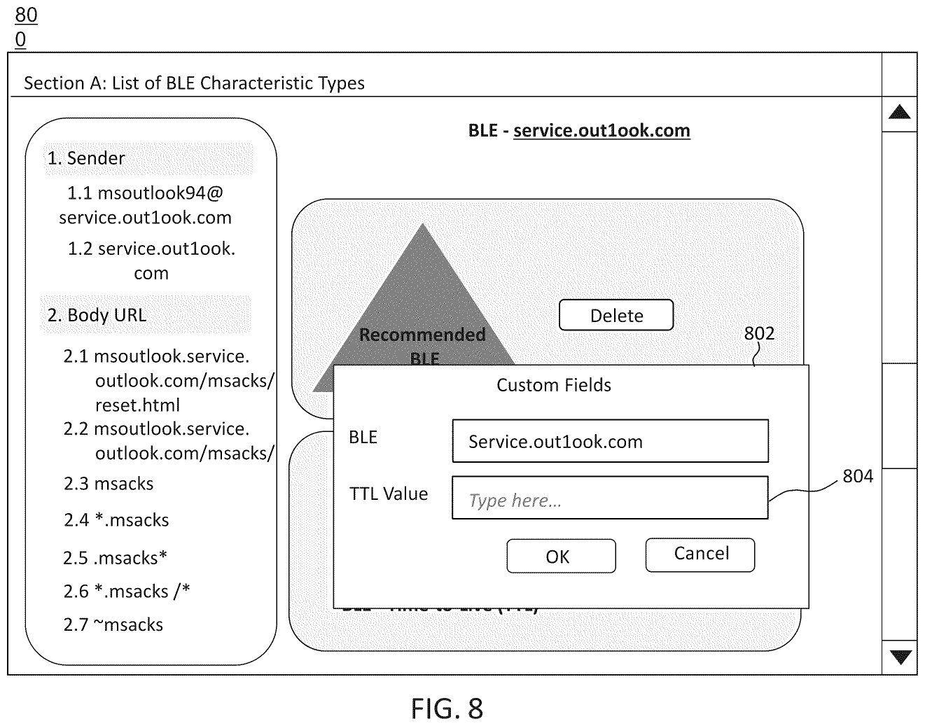

FIG. 8 illustrates an example of another pop-up menu 802 for adjusting the value of TTL for the BLE “service.outlook.com”, according to some embodiments.

In an implementation, if the system administrator clicks on edit button 604 (as shown in FIG. 6A), pop-up menu 802 is displayed to the system administrator. As shown in FIG. 8, text box 804 for a written response may be provided to the system administrator. In an example, the system administrator may input the response in text box 804. For example, the system administrator may input a new value of the TTL for the BLE “service.outlook.com”.

According to an implementation, blocklist manager 254 may identify existing BLEs in the blocklist that are related to topics that have been addressed in security awareness training provided to users of the organization. This may be augmented with an indication of the number or proportion of the users that have received the security awareness training or related training, the number or proportion of the users that have completed the security awareness training or related training, and the number or proportion of the users that have passed simulated phishing tests related to the BLEs. In an implementation, blocklist manager 254 may receive input from the system administrator to remove a BLE matching those criteria on security awareness training from the blocklist.

In an implementation, blocklist manager 254 may identify BLEs that have low efficacy levels and short remaining TTLs as candidate BLEs for removal from the blocklist. According to an implementation, blocklist manager 254 may recommend or rank the BLEs in order of which BLEs can most safely be removed (for example, based on remaining TTL, associated security awareness training provided, etc.). According to an implementation, blocklist manager 254 may receive an input from the system administrator to remove a BLE matching these criteria from the blocklist.

In some implementations, blocklist manager 254 may use Machine Learning (ML) techniques to learn from the BLEs which the system administrator rejects. The rejection of the BLEs may be based on the settings and choices that the system administrator provides. In an implementation, blocklist manager 254 may automatically update default settings to improve the recommended BLEs or TTLs recommended by BLE recommendation unit 252.

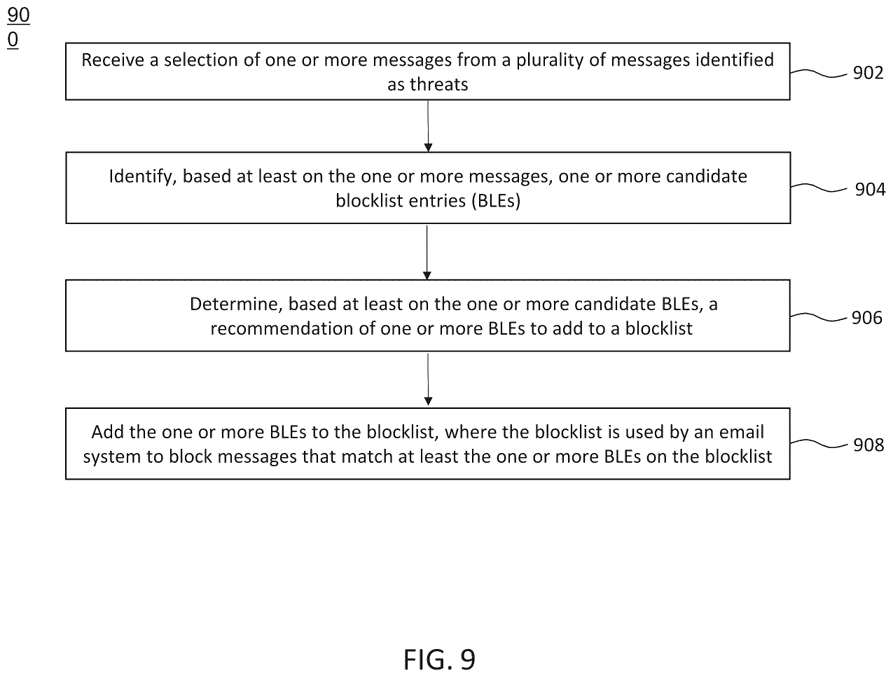

FIG. 9 depicts flowchart 900 for determining a recommendation of one or more BLEs to add to a blocklist, according to some embodiments.

In a brief overview of an implementation of flowchart 900, at step 902, a selection of one or more messages from a plurality of messages identified as threats may be received. At step 904, based at least on the one or more messages, one or more candidate BLEs may be identified. At step 906, a recommendation of one or more BLEs to add to a blocklist may be determined based at least on the one or more candidate BLEs. At step 908, the one or more BLEs may be added to the blocklist, where the blocklist is used by email system 204 to block messages that match at least the one or more BLEs on the blocklist.

Step 902 includes receiving a selection of one or more messages from a plurality of messages identified as threats. According to an implementation, blocklist generation system 210 may be configured to receive the selection of the one or more messages from the plurality of messages identified as threats. In an implementation, blocklist generation system 210 may receive the plurality of messages from threat detection system 208. Threat detection system 208 may add a label to the one or more messages to identify potential threats in the one or more messages. In examples, blocklist generation system 210 may receive the selection of the one or more messages from an administrator (or a system administrator) via a user interface (for example, administrator interface 284).

Step 904 includes identifying, based at least on the one or more messages, one or more candidate BLEs. According to an implementation, blocklist generation system 210 may be configured to identify, based at least on the one or more messages, the one or more candidate BLEs.

Step 906 includes determining, based at least on the one or more candidate BLEs, a recommendation of one or more BLEs to add to a blocklist. The blocklist may be a private blocklist. According to an implementation, blocklist generation system 210 may be configured to determine, based at least on the one or more candidate BLEs, the recommendation of one or more BLEs to add to the blocklist. In an implementation, blocklist generation system 210 may determine the recommendation of the one or more BLEs to add to the blocklist according to a BLE characteristic type of a plurality of BLE characteristic types. According to an implementation, blocklist generation system 210 may provide a user interface (for example, administrator interface 284) to the administrator to select a priority level for which to block messages similar to the plurality of messages identified as threats. In an implementation, blocklist generation system 210 may determine the recommendation of the one or more BLEs based at least on the selected priority level. According to an implementation, blocklist generation system 210 may determine a recommendation of a TTL for each of the one or more BLEs. In an implementation, blocklist generation system 210 may provide a priority indicator to each of the one or more BLEs. The priority indicator indicates an order for which each of the one or more BLEs are to be added to the blocklist used by email system 204. In an implementation, blocklist generation system 210 may determine an efficacy level for each of the one or more BLEs based at least on how often each of the one or more BLEs results in a message being blocked. According to an implementation, blocklist generation system 210 may receive a global blocklist of one or more BLEs identified by security services provider 212 that aggregates private blocklists of multiple organizations.

Step 908 includes adding the one or more BLEs to the blocklist, where the blocklist is used by email system 204 to block messages that match at least the one or more BLEs on the blocklist. According to an implementation, blocklist generation system 210 may be configured to add the one or more BLEs to the blocklist, where the blocklist is used by email system 204 to block messages that match at least the one or more BLEs on the blocklist.

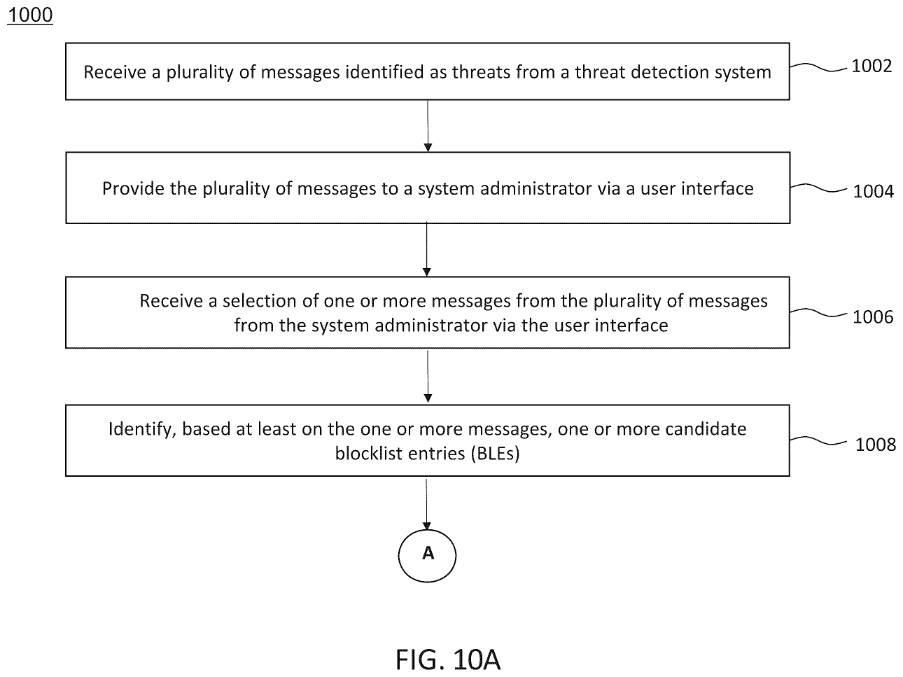

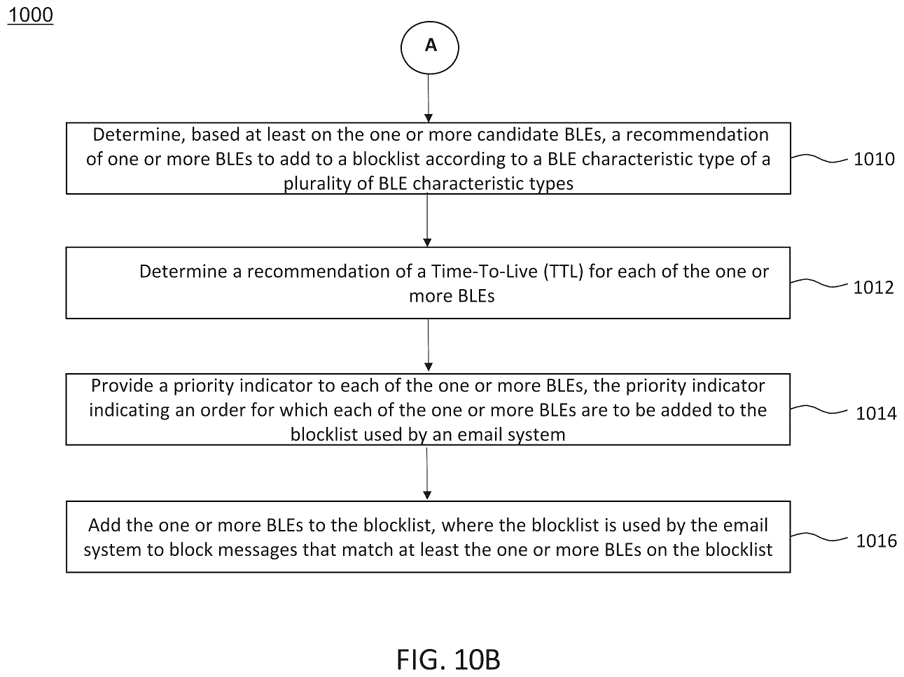

FIG. 10A and FIG. 10B depict another flowchart 1000 for determining a recommendation of one or more BLEs to add to a blocklist, according to some embodiments.

In a brief overview of an implementation of flowchart 1000, at step 1002, a plurality of messages identified as threats may be received from threat detection system 208. At step 1004, the plurality of messages may be provided to a system administrator (also referred to as an administrator) via a user interface (for example, administrator interface 284). At step 1006, a selection of one or more messages from the plurality of messages may be received from the system administrator via the user interface. At step 1008, one or more candidate BLEs may be identified based at least on the one or more messages. At step 1010, based at least on the one or more candidate BLEs, a recommendation of one or more BLEs to add to a blocklist according to a BLE characteristic type of a plurality of BLE characteristic types may be determined. At step 1012, a recommendation of a TTL for each of the one or more BLEs may be determined. At step 1014, a priority indicator may be provided to each of the one or more BLEs. The priority indicator may indicate an order for which each of the one or more BLEs are to be added to the blocklist used by email system 204. At step 1016, the one or more BLEs may be added to the blocklist. The blocklist may be used by email system 204 to block messages that match at least the one or more BLEs on the blocklist.

Step 1002 includes receiving a plurality of messages identified as threats from threat detection system 208. According to an implementation, blocklist generation system 210 may be configured to receive the plurality of messages identified as threats from threat detection system 208. In an implementation, threat detection system 208 may add a label to the one or more messages to identify potential threats in the one or more messages.

Step 1004 includes providing the plurality of messages to a system administrator via a user interface. According to an implementation, blocklist generation system 210 may be configured to provide the plurality of messages to the system administrator via the user interface (for example, administrator interface 284).

Step 1006 includes receiving a selection of one or more messages from the plurality of messages from the system administrator via the user interface. According to an implementation, blocklist generation system 210 may be configured to receive the selection of one or more messages from the plurality of messages from the system administrator via the user interface.

Step 1008 includes identifying, based at least on the one or more messages, one or more candidate BLEs. According to an implementation, blocklist generation system 210 may be configured to identify, based at least on the one or more messages, one or more candidate BLEs.

Step 1010 includes determining, based at least on the one or more candidate BLEs, a recommendation of one or more BLEs to add to a blocklist according to a BLE characteristic type of a plurality of BLE characteristic types. In an example, the blocklist may be a private blocklist. According to an implementation, blocklist generation system 210 may be configured to determine, based at least on the one or more candidate BLEs, the recommendation of the one or more BLEs to add to the blocklist according to the BLE characteristic type of the plurality of BLE characteristic types. In an implementation, blocklist generation system 210 may provide a user interface to the administrator to select a priority level for which to block messages similar to the plurality of messages identified as threats. In an implementation, blocklist generation system 210 may determine the recommendation of the one or more BLEs based at least on the selected priority level.

Step 1012 includes determining a recommendation of a TTL for each of the one or more BLEs. According to an implementation, blocklist generation system 210 may be configured to determine the recommendation of the TTL for each of the one or more BLEs.

Step 1014 includes providing a priority indicator to each of the one or more BLEs. The priority indicator indicates an order for which each of the one or more BLEs are to be added to the blocklist used by email system 204. According to an implementation, blocklist generation system 210 may be configured to provide the priority indicator to each of the one or more BLEs.

Step 1016 includes adding the one or more BLEs to the blocklist, where the blocklist is used by email system 204 to block messages that match at least the one or more BLEs on the blocklist. According to an implementation, blocklist generation system 210 may be configured to add the one or more BLEs to the blocklist. In an implementation, blocklist generation system 210 may determine an efficacy level for each of the one or more BLEs based at least on how often each of the one or more BLEs results in a message being blocked.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method comprising:
receiving, by one or more severs, a selection of one or more messages from a plurality of messages identified as threats;
identifying, by the one or more servers based at least on the one or more messages, one or more candidate blocklist entries (BLEs);
determining, by the one or more servers based at least on the more or more candidate BLEs, a recommendation of one or more BLEs to add to a blocklist; and
adding, by the one or more servers, the one or more BLEs to the blocklist, wherein the blocklist is used by an email system to block messages that match at least the one or more BLEs on the blocklist.

2. The method of claim 1, further comprising receiving, by the one or more servers, the plurality of messages from a threat detection system.

3. The method of claim 2, further comprising adding, by the threat detection system, a label to the one or more messages to identify potential threats in the one or more messages.

4. The method of claim 1, further comprising receiving, by the one or more servers, the selection of the one or more messages from an administrator via a user interface.

5. The method of claim 1, further comprising determining, by the one or more servers, the recommendation of the one or more BLEs to add to the blocklist according to a BLE characteristic type of a plurality of BLE characteristic types.

6. The method of claim 1, further comprising providing, by the one or more servers, a user interface to an administrator to select a confidence level for which to block messages similar to the plurality of messages identified as threats.

7. The method of claim 6, further comprising determining, by the one or more servers, the recommendation of the one or more BLEs based at least on the selected confidence level.

8. The method of claim 1, further comprising determining, by the one or more servers, a recommendation of a Time-To-Live (TTL) for each of the one or more BLEs.

9. The method of claim 1, wherein the blocklist is a private blocklist.

10. The method of claim 1, further comprising receiving, by the one or more processors, a global blocklist of one or more BLEs identified by a security services provider that aggregates private blocklists of multiple organizations.

11. The method of claim 1, further comprising providing, by the one or more processors, a priority indicator to each of the one or more BLEs, the priority indicator indicating an order for which each of the one or more BLEs are to be added to the blocklist used by the email system.

12. The method of claim 1, further comprising determining, by the one or more processors, an efficacy level for each of the one or more BLEs based at least on how often each of the one or more BLEs results in a message being blocked.

13. A system comprising:
one or more severs configured to:
receive a selection of one or more messages from a plurality of messages identified as threats;
identify, based at least on the one or more messages, one or more candidate blocklist entries (BLEs);
determine, based at least on the more or more candidate BLEs, a recommendation of one or more BLEs to add to a blocklist; and
add, the one or more BLEs to the blocklist, wherein the blocklist is used by an email system to block messages that match at least the one or more BLEs on the blocklist.

14. The system of claim 13, wherein the one or more servers are further configured to receive the plurality of messages from a threat detection system.

15. The system of claim 13, wherein the one or more servers are further configured to add a label to the one or more messages to identify potential threats in the one or more messages.

16. The system of claim 13, wherein the one or more servers are further configured to receive the selection of the one or more messages from an administrator via a user interface.

17. The system of claim 13, wherein the one or more servers are further configured to, the recommendation of the one or more BLEs to add to the blocklist according to a BLE characteristic type of a plurality of BLE characteristic types.

18. The system of claim 13, wherein the one or more servers are further configured to provide a user interface to an administrator to select a confidence level for which to block messages similar to the plurality of messages identified as threats.

19. The system of claim 18, wherein the one or more servers are further configured to determine the recommendation of the one or more BLEs based at least on the selected confidence level.

20. The system of claim 13, wherein the one or more servers are further configured to determine a recommendation of a Time-To-Live (TTL) for each of the one or more BLEs.

21. The system of claim 13, wherein the blocklist is a private blocklist.

22. The system of claim 13, wherein the one or more servers are further configured to receive a global blocklist of one or more BLEs identified by a security services provider that aggregates private blocklists of multiple organizations.

23. The system of claim 13, wherein the one or more processors are further configured to provide, a priority indicator to each of the one or more BLEs, wherein the priority indicator indicates an order for which each of the one or more BLEs are to be added to the blocklist used by the email system.

24. The system of claim 13, wherein the one or more processors are further configured to determine an efficacy level for each of the one or more BLEs based at least on how often each of the one or more BLEs results in a message being blocked.
